(19) United States
(12) Patent Application Publication
(10) Pub. No.: US 2014/0337986 A1
(43) Pub. Date: Nov. 13, 2014

(54) INFORMATION PROCESSING SYSTEM, INFORMATION PROCESSING APPARATUS, COMPUTER-READABLE STORAGE MEDIUM HAVING STORED THEREIN INFORMATION PROCESSING PROGRAM, AND DATA PROVIDING METHOD

(71) Applicant: NINTENDO CO., LTD., Kyoto (JP)

(72) Inventors: Ryusuke NIITANI, Kyoto (JP); Masahiro SHIOTANI, Kyoto (JP); Toyokazu NONAKA, Kyoto (JP); Takehiko HOSOKAWA, Kyoto (JP); Kouichi KAWAMOTO, Kyoto (JP)

(21) Appl. No.: 13/927,919

(22) Filed: Jun. 26, 2013

(30) Foreign Application Priority Data
May 8, 2013 (JP) 2013-098494

(51) Int. Cl. G06F 21/10

(52) U.S. Cl. CPC G06F 21/10
USPC 726/26

(57) ABSTRACT

An information processing system 100 includes an information processing apparatus 10 and a data providing server 20 that are capable of communication with each other over an IP network 40. The information processing apparatus 10 includes a storage unit 11 storing an integrated application program which includes a plurality of optional application programs that are independent of each other and which provides a cooperation function for the plurality of optional application programs. The data providing server 20 includes a storage unit 21 storing content data that is to be used by the optional application program. The information processing apparatus 10 includes a communication unit 13 for acquiring the content data from the data providing server 20.

### CROSS REFERENCE TO RELATED APPLICATION

The disclosure of Japanese Patent Application No. 2013-098494, filed on May 8, 2013, is incorporated herein by reference.

### FIELD

The technology herein relates to an information processing system including a terminal and a server that are capable of communicating with each other over a communication network, an information processing apparatus, a computer-readable storage medium having stored therein an information processing program, and a data providing method.

### BACKGROUND AND SUMMARY

Conventionally, there is known an information processing system that restricts execution of an application installed on an information processing apparatus, acquires a restriction release key according to a purchase operation of a user of the information processing apparatus, and releases the restriction on the execution, to thereby enable execution of the application by the information processing apparatus.

This application describes a new technology regarding execution restriction on an application and release thereof.

An information processing system of an example embodiment is an information processing system including a terminal and a server that are capable of communicating with each other over a communication network, wherein the terminal includes a first storage unit storing an optional application program whose execution is restricted and which can be executed by using restriction release data, wherein the server includes a second storage unit storing content data that is to be used by the optional application program, and wherein the terminal includes a content data acquisition unit for acquiring the content data from the server, and a restriction release data acquisition unit for acquiring the restriction release data.

According to this configuration, the content data is not stored in the terminal in a state where execution of the optional application program is restricted at the terminal, and thus, unnecessary data is not stored in the terminal and wasteful use of storage capacity may be suppressed. Also, the content data is not stored in the terminal in a state where execution of the optional application program is restricted at the terminal, and thus, even if the execution restriction on the optional application program is improperly released, there is no content data that can be used and execution is substantially impossible, and the execution restriction may be made effective.

The information processing system described above may include a determination unit for determining whether or not use of the optional application program by the terminal is allowed, wherein the content data acquisition unit may acquire the content data in a case where the determination unit determines that the use is allowed.

According to this configuration, execution restriction on the optional application program may be effectively released. Whether or not use is allowed may be determined based on the payment of charge, the result of some kind of information processing or the like, for example.

The terminal may acquire the content data and the restriction release data substantially at a same time.

According to this configuration, execution restriction on the optional application program may be effectively imposed or released.

The optional application program may become substantially executable by acquisition of the content data.

According to this configuration, execution restriction on the optional application program may substantially be imposed or released based on the absence of the content data. The execution restriction on the optional application program may thereby be made effective.

The first storage unit may store an integrated application program including a plurality of optional application programs that are independent of each other.

According to this configuration, since, compared to a case of not storing an optional application program in the terminal and thereby restricting execution of the optional application program, a plurality of optional application programs are provided in advance to the terminal as a part of the integrated application program, the complexity in the development is not increased and the development cost can be suppressed.

The integrated application program may include a basic application program that cooperates with at least one of the plurality of optional application programs.

According to this configuration, the cooperation function for the basic application program and the optional application program does not have to be externally prepared, and the complexity in the development is not increased and the development cost can be suppressed.

The basic application program may be executable regardless of whether or not the restriction release data is acquired by the restriction release data acquisition unit.

According to this configuration, the basic application program may become widely spread, and a greater number of users may be urged to acquire the optional application program.

An amount of data of the content data may be greater than an amount of data of the optional application program.

According to this configuration, the effect described above that wasteful use of storage capacity can be suppressed is enhanced.

An information processing system of another example embodiment is an information processing system including a terminal and a server that are capable of communicating with each other over a communication network, wherein the terminal includes a first storage unit storing an integrated application program including a plurality of optional application programs that are independent of each other, wherein the server includes a second storage unit storing content data that is to be used by the optional application programs, and wherein the terminal includes a content data acquisition unit for acquiring the content data from the server.

According to this configuration, the content data is not stored in the terminal in a state where execution of the optional application program is restricted at the terminal, and thus, unnecessary data is not stored in the terminal and wasteful use of storage capacity may be suppressed. Also, in the case where the terminal acquires the integrated application program over a network, the content data of the optional application program is not included in the data of the integrated application program, and thus, the time necessary for acquiring the integrated application program may be shortened. Furthermore, before the content data is acquired by the terminal, the content data of the optional application program is not stored in the terminal, and thus, execution of the optional application program is substantially impossible, and execution of the optional application program may thereby be restricted. Furthermore, according to the information processing system described above, since, compared to a case of not storing the optional application program that cooperates with other application programs in the terminal and thereby restricting execution of the optional application program, the optional application program is provided in advance to the terminal together with other application programs as the integrated application program, the cooperation function does not have to be externally prepared, and the complexity in the development is not increased and the development cost can be suppressed.

An information processing system of still another example embodiment is an information processing system including a terminal and a server that are capable of communicating with each other over a communication network, wherein the terminal includes a first storage unit storing an optional application program that is substantially executable by acquiring content data, wherein the server includes a second storage unit storing the content data that is to be use by the optional application program, and wherein the terminal includes a content data acquisition unit for acquiring the content data from the server.

Also according to this configuration, the content data is not stored in the terminal in a state where execution of the optional application program is restricted at the terminal, and thus, unnecessary data is not stored in the terminal and wasteful use of storage capacity may be suppressed. Furthermore, the content data is not stored in the terminal in a state where execution of the optional application program is restricted at the terminal, and thus, even if the execution restriction on the optional application program is improperly released, there is no data that can be used and execution is substantially impossible, and the execution restriction may be made effective. Moreover, according to the information processing system described above, in the case where the optional application program is to cooperate with other application programs stored in the terminal, since, compared to a case of not storing the optional application program in the terminal and thereby restricting execution of the optional application program, the optional application program is provided in advance to the terminal together with other application programs, the cooperation function does not have to be externally prepared, and the complexity in the development is not increased and the development cost can be suppressed.

A computer-readable storage medium of an example embodiment has stored therein an information processing program, wherein the information processing program causes a computer of an information processing apparatus including a first storage unit storing an optional application program whose execution is restricted and which can be executed by using restriction release data to function as a content data acquisition unit for acquiring content data that is to be used by the optional application program, a restriction release data acquisition unit for acquiring the restriction release data, and an information processing unit for releasing execution restriction on the optional application program by using the restriction release data acquired by the restriction release data acquisition unit, and for executing the optional application program by using the content data acquired by the content data acquisition unit. The same effect as the information processing system described above is achieved also according to this configuration.

An information processing apparatus of an example embodiment includes a first storage unit storing an optional application program whose execution is restricted and which can be executed by using restriction release data, a content data acquisition unit for acquiring content data that is to be used by the optional application program, a restriction release data acquisition unit for acquiring the restriction release data, and an information processing unit for releasing execution restriction on the optional application program by using the restriction release data acquired by the restriction release data acquisition unit, and for executing the optional application program by using the content data acquired by the content data acquisition unit. The same effect as the information processing system described above is achieved also according to this configuration.

A data providing method of an example embodiment is a data providing method of an information processing system including a terminal and a server that are capable of communicating with each other over a communication network, the method including storing an optional application program whose execution is restricted and which can be executed by using restriction release data in the terminal, storing content data that is to be used by the optional application program in the server, and acquiring, by the terminal, the content data and the restriction release data from the server. The same effect as the information processing system described above is achieved also according to this configuration.

These and other object, features, aspects and advantages of the technology will become more apparent from the following detailed description of non-limiting example embodiments when taken in conjunction with the accompanying drawings.

### BRIEF DESCRIPTION OF THE DRAWINGS

FIG. 1 shows an example non-limiting configuration of an information processing system;

FIG. 2 shows an example non-limiting configuration of an integrated application; and

FIG. 3 shows an example non-limiting configuration of the integrated application (after the purchase of a second application).

### DETAILED DESCRIPTION OF NON-LIMITING EXAMPLE EMBODIMENTS

Hereinafter, non-limiting example embodiments will be described with reference to the drawings. Additionally, the non-limiting example embodiments described below are examples for carrying out the technology, and do not restrict the technology to the concrete configurations described below. When carrying out the technology, a concrete configuration according to an embodiment may be applied as appropriate.

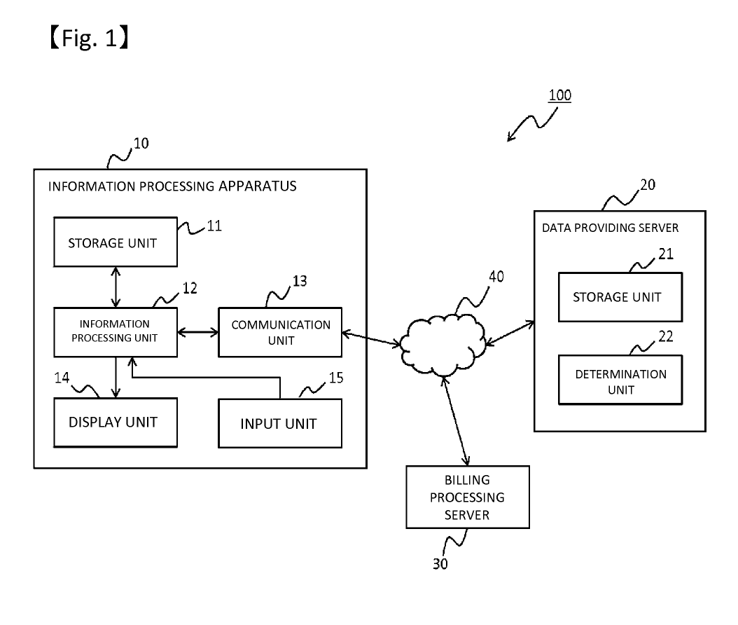

FIG. 1 shows an example non-limiting configuration of an information processing system. An information processing system 100 includes an information processing apparatus 10 as a terminal, a data providing server 20, and a billing processing server 30. The information processing apparatus 10 and the data providing server 20, and the billing processing server 30 and the data providing server 20, are capable of performing data communication with each other over an IP network 40 (including the Internet) as a communication network. The information processing apparatus 10 connects to the IP network 40 in a wireless or wired manner.

In a present embodiment, the information processing apparatus 10 is a game device capable of executing a game application. The information processing apparatus 10 may be a portable device or a stationary device. Also, the information processing apparatus 10 may be an information processing apparatus such as a smartphone, a PC (stationary, notebook-type, tablet-type) or of other mode that is capable of executing a game application. The present embodiment is advantageous especially when the information processing apparatus 10 is a portable device with a limited storage capacity. Moreover, the information processing apparatus 10 may also be capable of executing other applications instead of or in addition to a game application.

The data providing server 20 provides content data and restriction release data described later to the information processing apparatus 10. To this end, the data providing server 20 includes a storage unit 21 storing the content data and the restriction release data. This storage unit 21 corresponds to a second storage unit.

The information processing apparatus 10 provides, to the data providing server 20, settlement information for receiving provision of the content data and the restriction release data. The data providing server 20 requests the billing processing server 30 for a billing process by this settlement information. When the request for a billing process is received, the billing processing server 30 performs the billing process, and returns the result to the data providing server 20. The data providing server 20 allows provision of the content data or the restriction release data to the corresponding information processing apparatus 10 upon reception of the result of the billing process. The information processing apparatus 10 downloads the content data and the restriction release data from the data providing server 20.

The information processing apparatus 10 includes a storage unit 11, an information processing unit 12, a communication unit 13, a display unit 14, and an input unit 15. The storage unit 11 stores an application program (may also be referred to simply as an application), the content data, and other types of data. The information processing unit 12 executes an application according to an input from the input unit 15 or the like, and outputs the result of execution to the display unit 14 or the communication unit 13. The communication unit 13 performs data communication with the data providing server 20 over the IP network 40. The display unit 14 displays an image according to information processing by the information processing unit 12. The input unit 15 receives an input from a user. Additionally, the display unit 14 and the input unit 15 may be integrally formed as a touch panel. Also, in the example in FIG. 1, the storage unit 11, the information processing unit 12, the communication unit 13, the display unit 14, and the input unit 15 are integrally formed as the information processing apparatus 10, but these components may be arranged being scattered over a plurality of devices. For example, the information processing apparatus 10 may include the storage unit 11 and the information processing unit 12, and the communication unit 13 may be a communication terminal that is externally attached to the information processing apparatus 10, and the display unit 14 and the input unit 15 may also be separate bodies from the information processing apparatus.

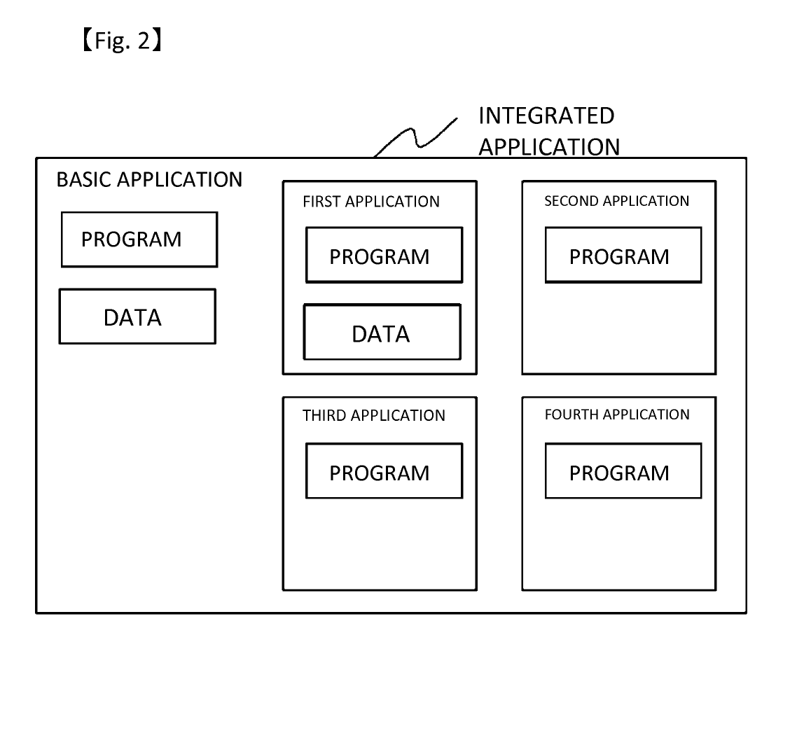

The storage unit 11 stores an integrated application. This storage unit 11 corresponds to a first storage unit. FIG. 2 is a diagram showing a configuration of the integrated application. The integrated application includes a basic application, and first to fourth optional applications (hereinafter, referred to simply as the first to fourth applications). The basic application and the first to fourth applications are applications that are related to each another. The basic application is a host application of the first to fourth applications, and the integrated application is an application assembling an application group of the first to fourth applications. The basic application has a function of cooperating with the first to fourth applications. The first to fourth applications are executed on the basic application, as a part of the integrated application.

The first to fourth applications are each an independent application. Specifically, the first to fourth applications are game applications for executing different games.

When the integrated application is started, the information processing unit 12 first executes the basic application. The basic application has a function of starting the first to fourth applications. As described above, the first to fourth applications are executed on the basic application. Among the first to fourth applications, an application whose execution is restricted cannot be started on the basic application.

The cooperation between the basic application and the first to fourth applications is also realized, for example, by using a process result of information processing at the basic application at the first to fourth applications. For example, the basic application is an application including a function of creating an avatar thereof and exchanging the avatar with other unspecific information processing apparatuses 10 by close proximity wireless communication. At this time, the avatar created by the basic application, avatars of others acquired by close proximity wireless communication, and the history of acquisition of the avatars of others acquired by close proximity wireless communication are used also by the first to fourth applications by the cooperation function.

At least one or some of the first to fourth applications are charged applications that become executable when the charge is paid. In the following, a case will be described where only the first application is executable, and the execution of the second to fourth applications is restricted. In this case, the integrated application including all of the first to fourth applications is stored in the storage unit 11. Moreover, this integrated application is provided at the data providing server 20, and may be stored in the storage unit 11 by being downloaded by the information processing apparatus 10 from the data providing server 20, or may be stored in the storage unit 11 by being read out from a computer-readable storage medium, not shown, or may be stored in the storage unit 11 at the time of shipping.

With respect to the second to fourth applications whose execution is restricted, content data used therefor is not stored in the storage unit 11. This content data is graphics data and/or sound data used by the applications. Generally, the amount of data is greater for the content data than for an application program. Accordingly, the content data of an application whose execution is restricted is not stored in the storage unit 11, and the capacity of the storage unit 11 may be prevented from being used unnecessarily.

Furthermore, the second to fourth applications become executable when the execution restriction is released by corresponding restriction release data (a restriction release code). The content data and the restriction release data may be acquired from the data providing server 20 by performing a charge payment process from the information processing apparatus 10 to the data providing server 20. Additionally, the second to fourth applications whose execution is restricted cannot be executed unless the execution restriction is released by the restriction release data, but even if the restriction is released by some improper means, the second to fourth applications are substantially not executable because the content data to be used for the second to fourth applications is not stored in the storage unit 11. The content data for the second to fourth applications and the restriction release data may be sold being stored in a storage medium. Additionally, the execution of the basic application is not restricted, and thus, it is executable regardless of whether or not the restriction release data is acquired, but in an example modification, the restriction on execution may also be imposed on the basic application.

The information processing apparatus 10 provides the settlement information input from the input unit 15 to the data providing server 20 via the communication unit 13 using the basic application. A determination unit 22 of the data providing server 20 issues a request for a billing process including this settlement information to the billing processing server 30, and allows download of the content data and the restriction release data by the corresponding information processing apparatus 10 upon receiving the result of the billing process from the billing processing server 30. Additionally, in the case where a result indicating that the billing process could not be performed is received from the billing processing server 30, the determination unit 22 does not allow download of the content data and the restriction release data by the corresponding information processing apparatus 10.

In the following, a process for releasing the execution restriction and allowing the execution of the second application by the information processing apparatus 10 will be described as an example. To purchase the second application (the content data and the restriction release data thereof), the communication unit 13 of the information processing apparatus 10 transmits, to the data providing server 20, the settlement information and a request for the content data and the restriction release data of the second application. When download is allowed by the data providing server 20, the communication unit 13 of the information processing apparatus 10 downloads the content data and the restriction release data from the data providing server 20 substantially at the same time. Additionally, to download substantially at the same includes sequentially downloading the content data and the restriction release data in one session. The communication unit 13 that downloads the content data corresponds to a content data acquisition unit, and the communication unit 13 that downloads the restriction release data corresponds to a restriction release data acquisition unit.

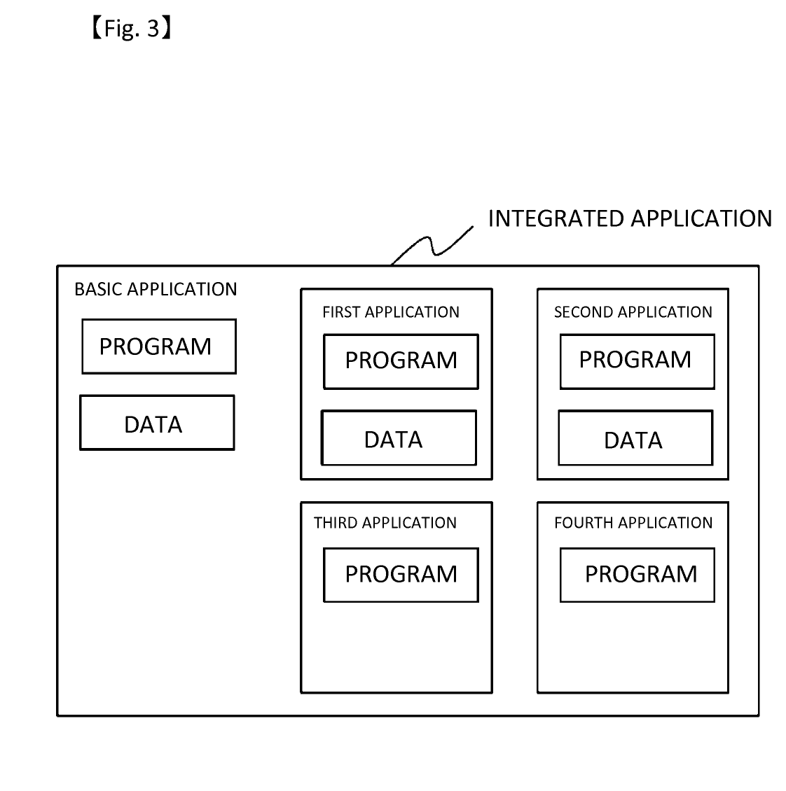

FIG. 3 shows a configuration of the integrated application after the acquisition of the content data and the restriction release data of the second application. When the restriction release data of the second application is acquired, the information processing unit 12 applies the data to the second application and enables execution of the second application. When the second application is started, the information processing unit 12 executes the second application using the content data of the second application stored in the storage unit 11.

As described above, with the information processing system 100 of the present embodiment, in a state where the execution of an optional application is restricted, the content data of the optional application is not stored in the information processing apparatus 10, and thus, unnecessary data is not stored in the information processing apparatus 10 and wasteful use of storage capacity may be suppressed.

Also, in the case of the information processing apparatus 10 acquiring the integrated application from a network, since, in a state where execution of an optional application is restricted, the content data of the optional application is not included in the integrated application data, and thus, the time necessary for acquiring the integrated application may be shortened.

Furthermore, in a state where execution of an optional application is restricted at the information processing apparatus 10, the content data of the optional application is not stored in the terminal, and thus, even if the execution restriction on the optional application is improperly released, there is no data that can be used and execution is substantially impossible, and the execution restriction may be made effective.

Furthermore, in the information processing system 100 described above, since, compared to a case of not storing an optional application that cooperates with another application in the information processing apparatus 10 and thereby restricting execution of the optional application, an optional application is provided to the information processing apparatus 10 in advance together with other applications as an integrated application, the cooperation function does not have to be externally prepared, and the complexity in the development is not increased and the development cost can be suppressed.

Additionally, in the embodiment described above, whether or not use of an optional application at the information processing apparatus 10 is allowed is determined based on the settlement, that is, the payment of the charge, and the restriction release data and the content data are provided from the data providing server 20 to the information processing apparatus 10 in the case where use is allowed, but whether or not use of an optional application at the information processing apparatus 10 is allowed may be determined based on other conditions. For example, use of an optional application at the information processing apparatus 10 may be allowed based on an execution result of another application at the information processing apparatus 10 or when a predetermined operation such as user registration is performed by the information processing apparatus 10 to the server. Also, in the embodiment described above, the data providing server 20 determines whether or not use of an optional application is allowed, but this is not restrictive, and the information processing apparatus 10 may determine whether or not use is allowed, and may request for the content data in the case where the result of the determination is positive.

Furthermore, in the embodiment described above, execution of an optional application whose use is not allowed is restricted, and the application becomes executable when the restriction is released by the restriction release data, but the execution restriction related to the restriction release data does not have to be imposed on an optional application whose use is not allowed. This is because, with the information processing system 100, content data that is to be used by an optional application can be downloaded only after use of the optional application is allowed, and even if an optional application is executable in a state where execution restriction is not imposed but use is not allowed, the optional application is substantially unusable in a state where the content data is not downloaded.

Moreover, in the embodiment described above, the information processing apparatus 10 includes the information processing unit 12 that executes an application, and the communication unit 13 that acquires the content data and the restriction release data, but the information processing unit 12 that executes an application may be provided to a device different from the information processing apparatus including the communication unit 13 that acquires the content data and the restriction release data.

Moreover, in the embodiment described above, the basic application and the first to fourth applications are applications that are related to each another, and the basic application is the application providing the cooperation function, but in addition or instead, the first to fourth applications may cooperate with one another, and in this case, the basic application may provide a cooperation function for those cooperation.

While the technology has been described in detail, the foregoing description is in all aspects illustrative and not restrictive. It will be understood that numerous other modifications and variations can be devised.

What is claimed is:

1. An information processing system including a terminal and a server that are capable of communicating with each other over a communication network,
wherein the terminal includes a first storage unit storing an optional application program whose execution is restricted and which can be executed by using restriction release data,
wherein the server includes a second storage unit storing content data that is to be used by the optional application program, and
wherein the terminal includes a content data acquisition unit for acquiring the content data from the server, and a restriction release data acquisition unit for acquiring the restriction release data.

2. The information processing system according to claim 1, comprising:
a determination unit for determining whether or not use of the optional application program by the terminal is allowed,
wherein the content data acquisition unit acquires the content data in a case where the determination unit determines that the use is allowed.

3. The information processing system according to claim 1, wherein the terminal acquires the content data and the restriction release data substantially at a same time.

4. The information processing system according to claim 1, wherein the optional application program becomes substantially executable by acquisition of the content data.

5. The information processing system according to claim 1, wherein the first storage unit stores an integrated application program including a plurality of optional application programs that are independent of each other.

6. The information processing system according to claim 5, wherein the integrated application program includes a basic application program that cooperates with at least one of the plurality of optional application programs.

7. The information processing system according to claim 6, wherein the basic application program is executable regardless of whether or not the restriction release data is acquired by the restriction release data acquisition unit.

8. The information processing system according to claim 1, wherein an amount of data of the content data is greater than an amount of data of the optional application program.

9. An information processing system including a terminal and a server that are capable of communicating with each other over a communication network,
wherein the terminal includes a first storage unit storing an integrated application program including a plurality of optional application programs that are independent of each other,
wherein the server includes a second storage unit storing content data that is to be used by the optional application programs, and
wherein the terminal includes a content data acquisition unit for acquiring the content data from the server.

10. The information processing system according to claim 1, wherein the optional application program is a game application program.

11. A computer-readable storage medium having stored therein an information processing program, wherein the information processing program causes a computer of an information processing apparatus including a first storage unit storing an optional application program whose execution is restricted and which can be executed by using restriction release data to function as:
a content data acquisition unit for acquiring content data that is to be used by the optional application program;
a restriction release data acquisition unit for acquiring the restriction release data; and
an information processing unit for releasing execution restriction on the optional application program by using the restriction release data acquired by the restriction release data acquisition unit, and for executing the optional application program by using the content data acquired by the content data acquisition unit.

12. An information processing apparatus comprising:
a first storage unit storing an optional application program whose execution is restricted and which can be executed by using restriction release data;
a content data acquisition unit for acquiring content data that is to be used by the optional application program;
a restriction release data acquisition unit for acquiring the restriction release data; and
an information processing unit for releasing execution restriction on the optional application program by using the restriction release data acquired by the restriction release data acquisition unit, and for executing the optional application program by using the content data acquired by the content data acquisition unit.

13. A data providing method of an information processing system including a terminal and a server that are capable of communicating with each other over a communication network, the method comprising:
storing an optional application program whose execution is restricted and which can be executed by using restriction release data in the terminal;
storing content data that is to be used by the optional application program in the server; and
acquiring, by the terminal, the content data and the restriction release data from the server.
